(19) United States
(12) Patent Application Publication
(10) Pub. No.: US 2007/0227570 A1
(43) Pub. Date: Oct. 4, 2007

(54) Adult Walker Lock-Release Apparatus

(75) Inventors: Bradley D. Gale, Rochester, NY (US); Joshua A. Trimble, Franklin, IN (US); David Chen, Taipei City (TW); Sean Ho, Taipei County (TW)

Correspondence Address: BARNES & THORNBURG LLP, 11 SOUTH MERIDIAN, INDIANAPOLIS, IN, 46204, US

(73) Assignee: COSCO MANAGEMENT, INC., Wilmington, DE (US)

(21) Appl. No.: 11/692,859

(22) Filed: Mar. 28, 2007

Related U.S. Application Data
(60) Provisional application No. 60/744,007, filed on Mar. 30, 2006.

(51) Int. Cl. A61H 3/00

(52) U.S. Cl. 135/67

(57) ABSTRACT

An adult walker for use by persons in need of ambulatory assistance includes laterally spaced first and second collapsible side frame units to allow a user to collapse first and second collapsible side frame units between an unfolded use position and a folded storage position.

This application claims priority under U.S.C. §119(e) to U.S. Provisional Application Ser. No. 60/744007, filed March 30, 2006, which is expressly incorporated by reference herein.

### BACKGROUND

The present disclosure relates to ambulatory aids, and in particular to walkers. More particularly, the present disclosure relates to collapsible and height-adjustable adult walkers.

### SUMMARY

A adult walker in accordance with the present disclosure includes a collapsible frame having four legs, a pair of upwardly extending push arms mounted to top of the frame, and a wheel unit coupled to the bottom of each leg. The collapsible frame is configured for movement between an unfolded use position and a folded storage position.

In illustrative embodiments, the collapsible frame includes a pair of spaced-apart “four-bar” linkages. Each four-bar linkage includes first, second, third, and fourth bars pivotably coupled to one another such that a pivot joint is established between each pair of adjacent bars. The pivot joints are configured for movement of the four-bar linkages between the unfolded use position and the folded storage position.

In illustrative embodiments, the collapsible frame further includes a lock and a lock release associated with each fourth bar to block movement of the four-bar linkages to retain the collapsible frame in the unfolded use position. A single actuator coupled to both lock releases is configured to allow a user to unlock both locks simultaneously with one hand so that the collapsible frame can be moved to the folded storage position

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of an adult walker in accordance with the present disclosure, with portions broken away, showing laterally spaced first and second collapsible side frame units, each side frame unit having a front leg, a rear leg, upper and lower links extending between the front and rear legs, two upwardly extending push arms coupled to companion side frame units, two wheel units being coupled to a lower portion of each side frame unit, a portion of a seat-and-basket unit positioned to lie between the first and second side frame units, and a lower crossbar coupled to the first and second side frame units and located below the seat-and-basket unit, a bridge link lock arranged to lock each upper link between the front and rear legs to maintain the side frame units in an unfolded use position (shown), and a one-hand lock-release actuator coupled to the crossbar to unlock both lock assemblies to allow the user to collapse the side frame units toward a folded storage position (shown in FIG. 2);

FIG. 2 is a view similar to FIG. 1 showing a partly collapsed adult walker during movement from the expanded use position toward the collapsed storage position;

FIG. 3 is an enlarged exploded perspective view of illustrative components included in the bridge link lock of FIGS. 1 and 2, with portions broken away, showing (from top to bottom) a cable end portion, a protective guard, a pin mover, a pin receiver channel formed in a jaw assembly coupled to the rear leg of the collapsible frame, the front leg having an upper link mounting bracket, an upper “bridge” link, and a lock pin coupled to the bridge link;

FIG. 4 is an enlarged perspective view of the pin mover of FIG. 3;

FIG. 5 is a sectional view taken along line 5-5 of FIG. 1 showing the bridge link lock when the side frame unit is in the expanded use position;

FIG. 6 is an enlarged side elevation view of the adult walker lock-release apparatus, with portions broken away, showing the one-hand actuator and one of the bridge link locks when the side frame unit is in the expanded use position;

FIG. 7 is a view similar to FIG. 6, showing a hand of a user grasping and squeezing a finger-receiving portion of the one-hand actuator to cause a first and a second puller hook portion to pull a companion cable end toward a center portion of the actuator to cause the pin mover to free the lock pin for movement out of and away from the pin-retainer channel; and

FIG. 8 is a view similar to FIGS. 6 and 7 showing the bridge link lock during movement from the expanded use position toward the collapsed storage position.

### DETAILED DESCRIPTION

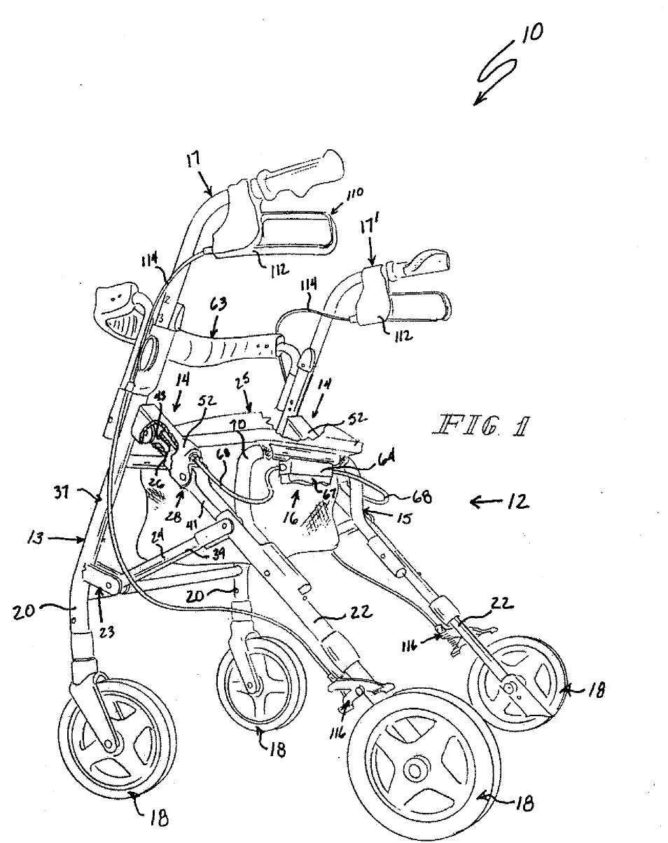

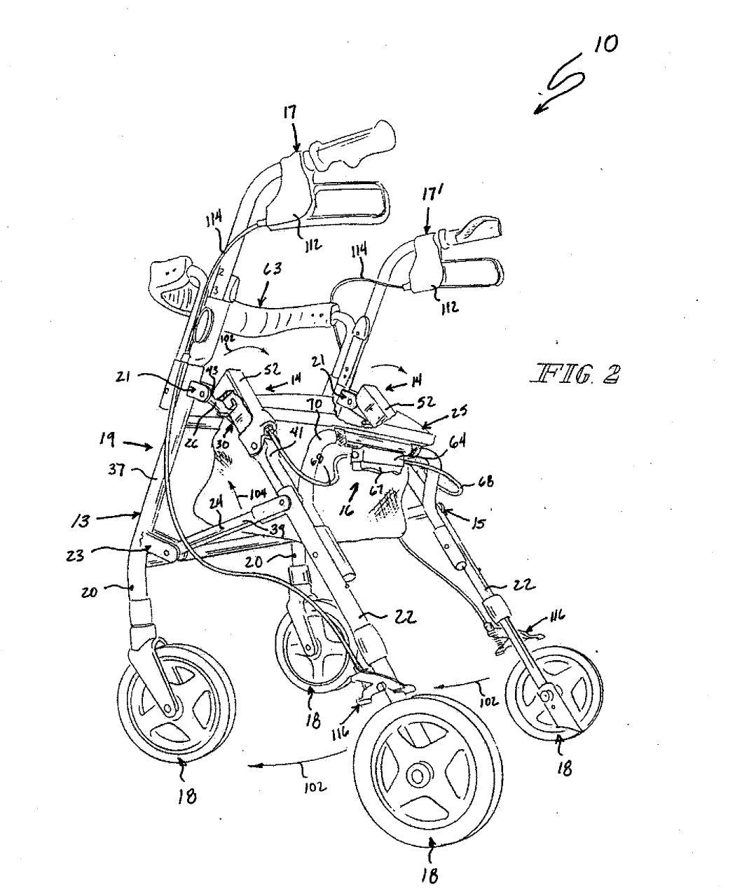

An adult walker 10 for use by persons in need of ambulatory assistance includes a base 12 including laterally spaced first and second collapsible side frame units 13, 15 to allow a user to collapse first and second collapsible side frame units 13, 15 between an unfolded use position and a folded storage position, as shown in FIGS. 1 and 2. In illustrative embodiments, adult walker 10 further includes a pair of locks 14, and a pair of associated lock releases 16 as shown, for example, in FIG. 1. Locks 14 are arranged to lock first and second collapsible side frame units 13, 15 in an unfolded use position. Lock release 16 allows the user to unlock both locks 14 with one hand to allow the user to collapse first and second collapsible side frame units 13, 15 toward the folded storage position.

Each collapsible side frame unit 13, 15 further includes a first leg unit 20 having an upper mounting bracket 21 and a lower mounting bracket 23, a second leg unit 22, and a lower link 24 pivotably coupled to and extending between lower mounting bracket 23 of first leg unit 20 and second leg unit 22. In illustrative embodiments, first leg unit 20 is a front leg 20 and each second leg unit 22 is a rear leg 22.

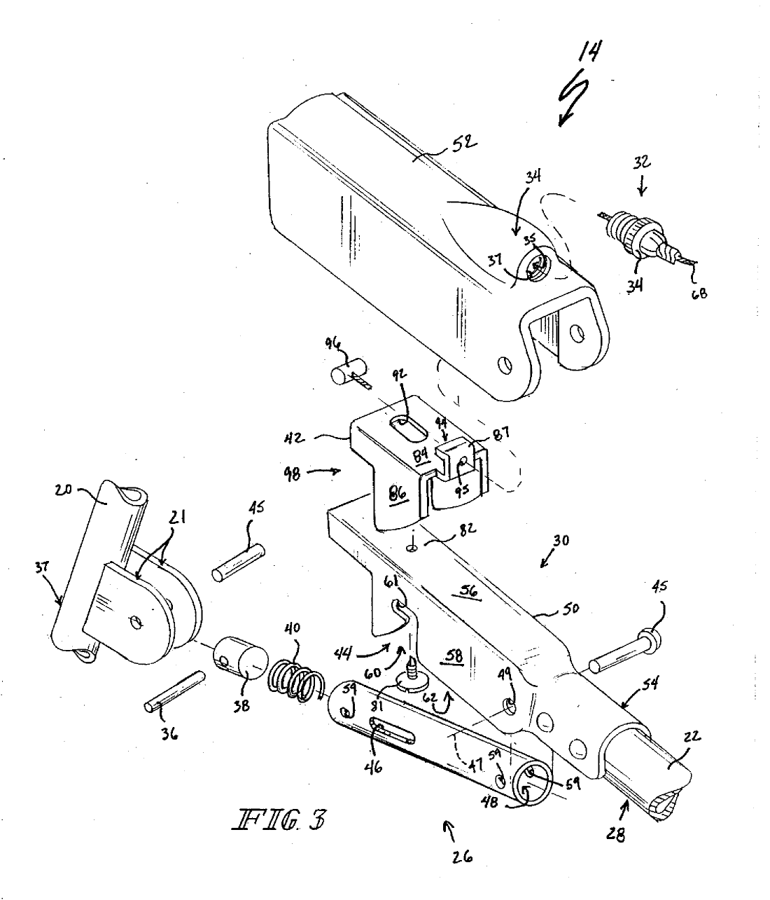

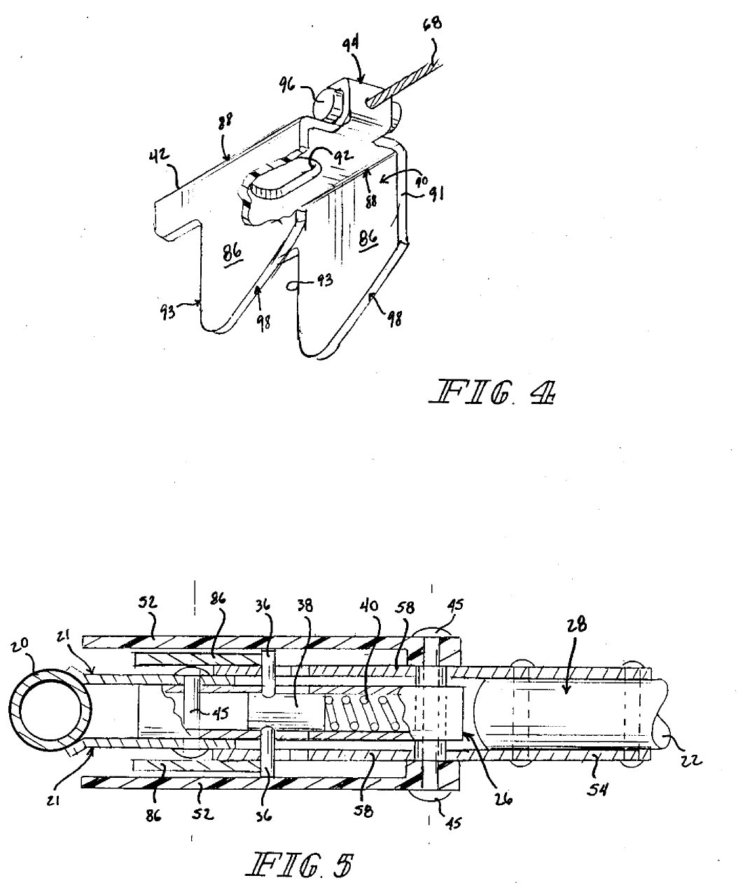

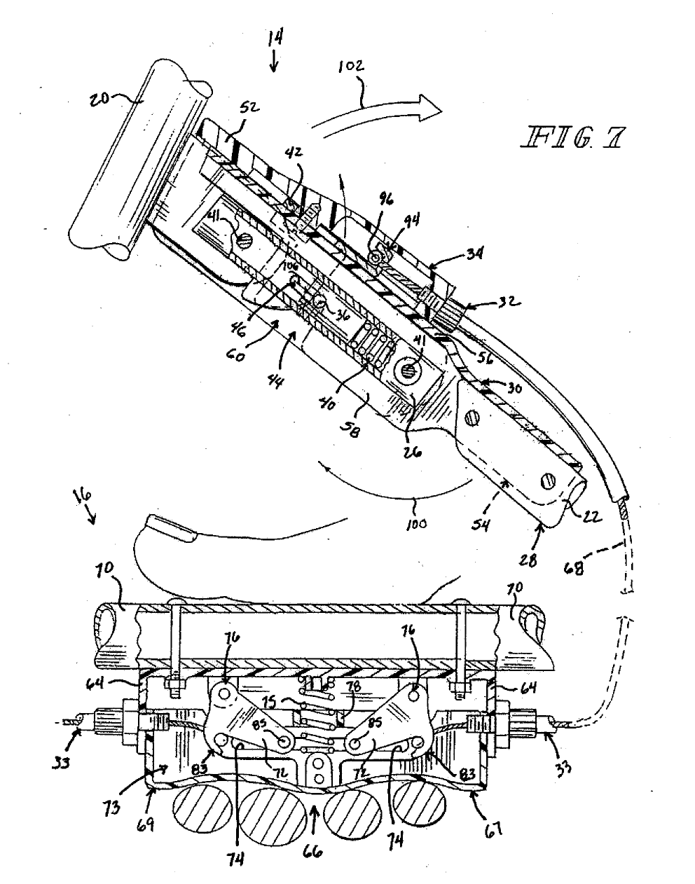

Lock 14 includes an upper “bridge” link 26 located between first leg unit 20 and second leg unit 22, a lock pin 36, a pin carrier 38 configured to receive lock pin 36 therethrough, a U-shaped jaw assembly 30 coupled to a top end 28 of rear leg 22 and formed to include a pair of R-shaped pin receiver channels 44, and a spring 40 as shown in FIG. 3. Lock 14 is configured to block movement of bridge link 26 relative to front and rear legs 20, 22 and maintain bridge link 26 in an in-line locked position, as shown best in FIGS. 1 and 6. Lock 14 further allows the user to enable movement of bridge link 26 relative to front and rear legs 20, 22 so that bridge link 26 and rear leg 22 can be moved to an angled unlocked position, as shown in FIGS. 2 and 8.

Lock release 16 includes a U-shaped protective guard 52 coupled to jaw assembly 30, a pin mover 42, a cable 68, and an actuator 66. Lock release 16 is configured to move lock 14 between a locked position, corresponding to the unfolded use position, and an unlocked position corresponding to the folded storage position. Lock release 16 is coupled to base 12 for movement relative thereto.

In illustrative embodiments, base 12 has two locks 14 and two lock releases 16 configured such that each collapsible side frame unit 13, 15 has one associated lock 14 and one lock release 16. However, it is within the scope of this disclosure to provide only a single lock 14 and a single lock release 16 associated with one of the collapsible side frame units 13, 15.

Referring now to FIG. 3, bridge link 26 is formed to include a pair of apertures 59 in each end portion to receive a pivot pin 45 for pivotably coupling bridge link 26 to upper mounting bracket 21 and to rear leg 22 to extend therebetween. Bridge link 26 is further formed to include a parallel pair of oblong pin-guide slots 46 longitudinally extending along a center portion of link 26. Bridge link 26 is tubular in cross-section so as to be formed to include a hollow region 48 through which, in series, pin carrier 38 and spring 40 extend. Lock pin 36 is coupled to pin carrier 38 and arranged to extend through oblong pin-guide slots 46. Bridge link 26 thus provides means for lock pin 36 and pin carrier 38 to move slidably in response to a bias force applied by spring 40.

Jaw assembly 30 includes a jaw 50, a sleeve portion 54, a planar portion 56, and a pair of spaced-apart flanges 58. Jaw 50 couples to and extends away from top end 28 of rear leg 22. Sleeve portion 54 couples to and substantially surrounds a portion of top end 28. Planar portion 56 couples to and extends away from sleeve portion 54 in an in-line relation to rear leg 22. Spaced-apart flanges 58 depend from planar portion 56 along a top edge of each flange 58 and further couple on a side edge to sleeve portion 54. Planar portion 56 cooperates with flanges 58 to form a U-shaped channel 62 therebetween. U-shaped channel 62 receives at least a portion of bridge link 26 when lock 14 is in the locked position where base 12 is in the unfolded use position.

Flanges 58 are formed to include R-shaped pin-receiver channels 44. Each pin-receiver channel 44 is formed to include a pin-capture notch 60 and a pin-keeper passage 61, as shown best in FIG. 3. Pin-capture notch 60 is configured to capture and guide lock pin 36 into pin-receiver channel 44 and pin-keeper passage 61 toward a mated position as lock 14 and jaw assembly 30 are moved from the unlocked position toward the locked position. Flanges 58 are further formed to include a pair of apertures 49 adjacent to sleeve portion 54. Apertures 49 align with companion apertures formed in bridge link 26 to receive pivot pin 45 therethrough to establish a pivot axis 47. Bridge link 26 pivots about pivot axis 47 relative to rear leg 22.

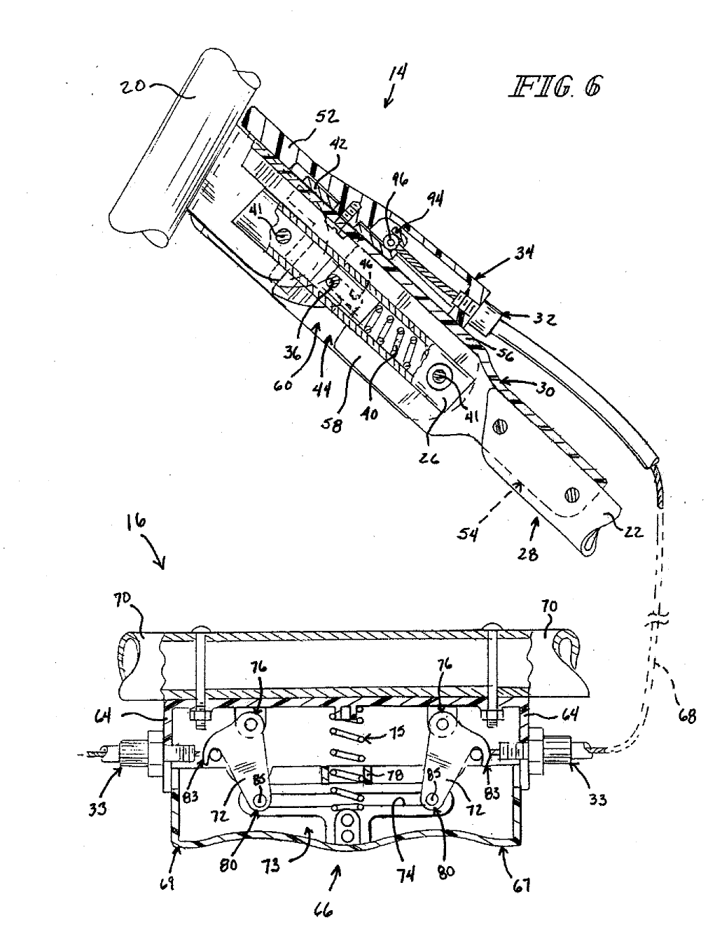

Protective guard 52 extends about jaw 50, as shown, for example, in FIGS. 3 and 6-8. Protective guard 52 cooperates with jaw 50 to define a pin-mover channel 51 configured to receive pin mover 42 therein for slidable movement relative to jaw 50, as shown best, for example, in FIG. 5. In illustrative embodiments, protective guard 52 substantially covers planar portion 56 and flanges 58 to protect the user from unintended contact with lock 14. Protective guard 52 is configured as a generally U-shaped jacket constructed of a plastics material. However, protective guard 52 may be constructed of any suitable material such as, for example, steel, aluminum, or wood. Protective guard 52 is formed to include cable connector assembly 34 having an aperture 37 configured to receive first cable end portion 32 therethrough to couple first cable end portion 32 to pin mover 42. Cable connector assembly 34 defines a cavity 35 arranged to receive a portion of pin mover 42 for slidable movement therein.

U-shaped pin mover 42 is slidably coupled to a first surface 82 of planar portion 56, as shown, for example, in FIG. 3. Pin mover 42 includes a horizontal wall 84, a pair of vertical walls 86 depending from opposite edges 88 of horizontal wall 84 to form a U-shaped channel 90 therebetween, and a cable anchor receiver 94. Horizontal wall 84 includes an oblong guide slot 92 configured to receive a fastener 81 therethrough to couple pin mover 42 to jaw 50.

Cable anchor receiver 94 includes a generally U-shaped flange 87 having an aperture 95 that receives a portion of cable 68 therethrough and couples to an edge adjacent to oblong guide slot of horizontal wall 84. U-shaped flange 87 extends upwardly from horizontal wall 84 and receives an anchor 96 coupled to first cable end portion 32 to interconnect each cable 68 with each pin mover 42. Each vertical wall 86 includes a first edge 91, a second edge 93, and a pin-pusher edge 98 extending between first edge 91 and second edge 93.

Pin-pusher edge 98 is generally oblique in relation to edges 91 and 93 and has a generally arcuate profile. Pin pusher edge 98 is arranged to confront lock pin 36 to push lock pin 36 out of pin-keeper passage 61 to an unmated position to unlock lock 14 and enable pivoting movement of bridge link 26 in relation to front and rear legs 20, 22 such that bridge link 26 is able to move to the angled unlocked position.

Lock release 16 further includes an actuator housing 64 arranged to mount actuator 66 and left and right cables 68, as shown in FIGS. 6-8. Actuator housing 64 is coupled to a crossbar 70 extending between left and right rear legs 22. Actuator 66 is coupled to housing 64 for slidable movement therein.

Actuator 66 includes a finger-receiving trigger 67, a pair of cable pullers 72, and a spring 75 as shown, for example, in FIGS. 6-8. Trigger 67 includes first and second segments 69, 71. First and second segments 69, 71 are coupled together to form unitary trigger 67 and cooperate to define an interior portion 73 of trigger 67. First and second segments 69, 71 are formed to include a cable puller guide 74 in an inner surface of each segment 69, 71 and a spring holder 77. Spring 75 is configured to exert a biasing force against trigger 67 to move trigger 67 away from housing 64.

Each cable puller 72 includes a hook portion 83 and a guide pin 85. Cable puller 72 pivotably couples on a first end 76 to housing 64 for pivotable movement thereto and extends downwardly into interior portion 73 of trigger 67. Cable puller 72 slidably couples on a lower second end 80 to cable puller guide 74. Guide pin 85 extends through second end 80 and couples to cable puller guide 74. Hook portion 83 receives a second cable end portion 33 of cable 68 for simultaneously moving each cable 68 upon application of an actuation force by the user so as to actuate lock release 16.

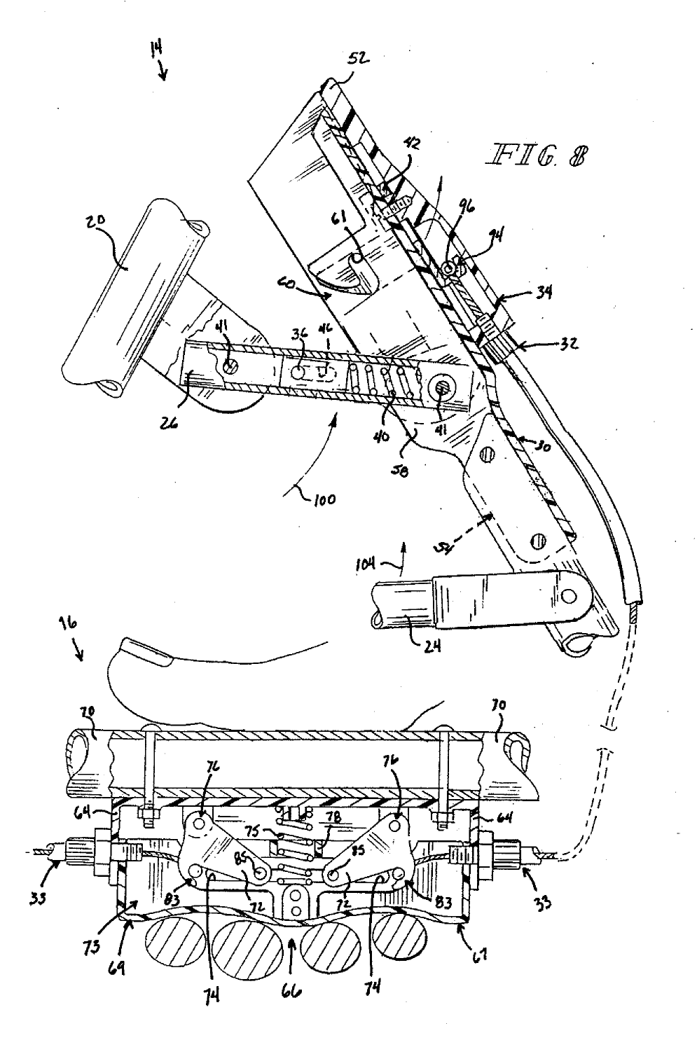

In operation, cable 68 is pulled toward actuator 66 in response to the manual operation of one-hand actuator 66 by the user, as suggested in FIGS. 7 and 8. As the actuation force is applied, cable 68 is moved away from lock 14, pin-pusher edge 98 of pin mover 42 confronts lock pin 36 to push lock pin 36 out of pin-keeper passage 61 in a direction 106 enabling movement of bridge link 26 to pivot counterclockwise in a direction 100 about front leg 20. Simultaneously, rear leg 22 pivots clockwise in a direction 102 about bridge link 26 away from front leg 20 and lower link 24 pivots counterclockwise with respect to front leg 20 in a direction 104 so that the user can collapse collapsible side frame units 13, 15 to a folded storage position.

First and second collapsible side frame units 13, 15 comprises a “four-bar” linkage. First leg unit 20 provides a first bar, second leg unit 22 provides a third bar, and lower link 24 provides a second bar pivotably coupled to and extending between the first and second bars. Bridge link 26 provides a fourth bar and is pivotably coupled to and extending between the third bar and the first bar.

First and second collapsible side frame units 13, 15 further include two upwardly extending push arms 17, 17′, each push arm 17, 17′ being coupled to an upper portion of companion first and second side frame units 13, 15, four wheel units 18, two wheel units 18 being coupled to a lower portion of first collapsible side frame unit 13 and two other wheel units 18 being coupled to a lower portion of second collapsible side frame unit 15, a seat-and-basket unit 25 positioned to lie between first and second side frame units 13, 15, a seat back 63 positioned to lie between first and second collapsible side frame units 13, 15, and a lower crossbar 70 coupled to first and second side frame units 13, 15 and located below seat-and-basket unit 25.

A braking system 110 is provided to assist the user in controlling the movement of adult walker 10 as shown once again in FIGS. 1 and 2. Braking system 110 includes a pair of hand brake actuators 112, a pair of brake cables 114 coupled to hand brake actuators 112 on a first end and coupled to a wheel brake 116 coupled to each rear leg 22 to arrest the rotation of wheel units 18 coupled thereto.

1. An adult walker comprising
first and second side frame units laterally spaced from one another, each side frame unit including first and second leg units, the first leg unit being coupled to the second leg unit, the first and second side frame units being movable between an unfolded use position and a folded storage position,
a lock coupled to each first and second side frame unit, each lock configured to retain respective first and second side frame units in the unfolded use position, and
unlocking means for moving each lock from a locked position to an unlocked position so that the first and second side frame units can be moved from the unfolded use position toward the folded storage position.

2. The adult walker of claim 1, wherein the unlocking means includes a lock release coupled to each lock and further coupled to an actuator, the actuator being configured to actuate both lock releases simultaneously.

3. The adult walker of claim 2, wherein the lock includes a bridge link located between the first and second leg units, a lock pin arranged to slide back and forth in a slot formed in the bridge link, and a jaw assembly coupled to the second leg unit and formed to include a pin-receiver channel, the pin-receiver channel arranged to receive the lock pin to block movement of the bridge link relative to the first and second leg units upon movement of the first and second side frame units to the unfolded use position.

4. The adult walker of claim 3, wherein the pin-receiver channel defines a pin-capture notch and a pin-keeper passage, and the pin-keeper passage is arranged to receive the lock pin when the first and second side frame units are moved toward the unfolded use position to block movement of the jaw assembly.

5. The adult walker of claim 3, wherein the lock release includes a pin mover coupled to the jaw assembly to confront the lock pin and a cable coupled to the pin mover and to the actuator, and the pin mover is arranged to move the lock pin toward the second leg in response to an actuation force being applied to the actuator.

6. The adult walker of claim 3, wherein the bridge link is formed to include a parallel pair of oblong apertures extending longitudinally along the bridge link and the lock pin extends through the apertures for slidable movement relative to the bridge link.

7. The adult walker of claim 1, wherein the lock includes a bridge link, a lock pin, and a jaw assembly, a first end of the bridge link is coupled to the first leg unit for pivotable movement thereabout and a second end of the bridge link is coupled to the second leg unit for pivotable movement thereabout, the lock pin is coupled to the bridge link, and the jaw assembly is coupled to an end of the second leg unit.

8. The adult walker of claim 7, wherein the bridge link is formed to include an interior channel and an exterior wall formed to include an elongated slot opening into the interior channel and the lock unit includes a pin carrier mounted for back-and-forth sliding movement in the interior channel, the lock pin is coupled to the pin carrier to move therewith relative to the bridge link and arranged to extend through the elongated slot, and a spring is arranged to lie in the interior channel and is configured to define means for yieldably moving the pin carrier in the interior channel to urge the lock pin to engage one end of the elongated slot.

9. The adult walker of claim 7, wherein the jaw assembly is U-shaped and is positioned to cover at least a portion of the bridge link when the first and second side frame units are in the unfolded use position.

10. The adult walker of claim 7, wherein the jaw assembly is formed to include a pin-receiver channel defining a pin-capture notch and a pin-keeper passage.

11. The adult walker of claim 10, wherein the lock pin is positioned to engage the pin-receiver channel when the first and second side frame units are in the unfolded use position.

12. An adult walker comprising
first and second side frame units laterally spaced from one another, each side frame unit including first and second leg units, the first leg unit being coupled to the second leg unit, and the first and second side frame units being movable between an unfolded use position and a folded storage position,
a lock coupled to each first and second side frame unit, each lock configured to retain respective first and second side frame units in the unfolded use position, and
a lock release coupled to each lock and further coupled to an actuator, the actuator being configured to actuate both lock releases simultaneously.

13. The adult walker of claim 12, wherein the lock includes a bridge link, a lock pin, and a jaw assembly, a first end of the bridge link is coupled to the first leg unit for pivotable movement thereabout and a second end of the bridge link is coupled to the second leg unit for pivotable movement thereabout, the lock pin is coupled to the bridge link, and the jaw assembly is coupled to an end of the second leg unit.

14. The adult walker of claim 12, wherein the bridge link is formed to include an interior channel and an exterior wall formed to include an elongated slot opening into the interior channel and the lock unit includes a pin carrier mounted for back-and-forth sliding movement in the interior channel, the lock pin is coupled to the pin carrier to move therewith relative to the bridge link and is arranged to extend through the elongated slot, and a spring is arranged to lie in the interior channel and is configured to define means for yieldably moving the pin carrier in the interior channel to urge the lock pin to engage one end of the elongated slot.

15. The adult walker of claim 12, wherein the jaw assembly is formed to include a cavity and a side wall formed to include a pin receiver, the bridge link is sized and arranged to lie in the cavity to cause the lock pin to extend into the pin receiver to block pivotable movement of the second leg unit relative to the bridge link.

16. The adult walker of claim 12, wherein the lock release includes a pin mover coupled to the jaw assembly to confront the lock pin and a cable coupled to the pin mover and to the actuator, the pin mover is arranged to move toward the second leg in response to an actuation force being applied to the actuator.

17. The adult walker of claim 16, wherein the pin mover is formed to include a cavity and a side wall and the jaw assembly is sized and arranged to lie in the cavity to cause the side wall to confront the lock pin.

18. An adult walker comprising
a base including first and second side frame units laterally spaced from one another, the first and second side frame units being movable between an unfolded use position and a folded storage position,
a lock coupled to each first and second side frame unit, and
a lock release coupled to the lock, the lock release including first and second cables and an actuator, the first and second cables extending from the actuator to a respective lock release, the actuator being arranged to unlock both locks simultaneously in response to an actuation force being applied to the actuator.

19. The adult walker of claim 18, wherein the lock includes a bridge link, a lock pin, and a jaw assembly, a first end of the bridge link is coupled to the first leg unit for pivotable movement thereabout and a second end of the bridge link is coupled to the second leg unit for pivotable movement thereabout, the lock pin is coupled to the bridge link, and the jaw assembly is coupled to an end of the second leg unit.

20. The adult walker of claim 19, wherein the bridge link is formed to include an interior channel and an exterior wall formed to include an elongated slot opening into the interior channel and the lock unit includes a pin carrier mounted for back-and-forth sliding movement in the interior channel, the lock pin is coupled to the pin carrier to move therewith relative to the bridge link and is arranged to extend through the elongated slot, and a spring is arranged to lie in the interior channel and is configured to define means for yieldably moving the pin carrier in the interior channel to urge the lock pin to engage one end of the elongated slot.

21. An adult walker comprising
a foldable four-bar linkage including first, second, third, and fourth bars, the second bar being pivotably coupled to each of the first and third bars, and the fourth bar being pivotably coupled to each of the first and third bars,
a lock release coupled to the second bar, and
a lock including a lock pin coupled to the fourth bar, a spring coupled to the fourth bar and arranged to yieldably urge the lock pin to move toward an end of the fourth bar, a jaw formed to include a pin receiver and coupled to the upper end of the third bar to receive the lock pin in the pin receiver upon movement of the foldable four-bar linkage to assume an unfolded shape to block pivotable movement of the third bar relative to the fourth bar to retain the foldable four-bar linkage in the unfolded shape.

22. The adult walker of claim 21, wherein the lock pin is arranged to slide back and forth in a slot formed in the fourth bar and the spring is coupled to the fourth bar and is arranged to yieldably urge the lock pin to move to one end of the slot.

23. The adult walker of claim 22, wherein the pin receiver is R-shaped and is arranged to receive the lock pin in a pin keeper portion of the R-shaped pin receiver upon movement of the foldable four-bar linkage to assume the unfolded shape.

24. The adult walker of claim 22, wherein the lock pin is arranged to be moved toward an opposite second end of the slot against a biasing force provided by the spring to exit the pin keeper portion of the R-shaped pin receiver formed in the jaw to free the third and fourth bars to pivot relative to one another to release the foldable four-bar linkage so that the foldable four-bar linkage can be moved to assume the folded shape.

25. An adult walker comprising
a side frame including first and second leg units, the first leg unit being coupled to the second leg unit, and the side frame being movable between an unfolded use position and a folded storage position,
a lock release coupled to the second leg unit, and
a lock coupled to the side frame, the lock configured to retain the side frame in the unfolded use position.

26. The adult walker of claim 25, the lock includes a bridge link, a lock pin, and a jaw assembly, a first end of the bridge link is coupled to the first leg unit for pivotable movement thereabout and a second end of the bridge link is coupled to the second leg unit for pivotable movement thereabout, the lock pin is coupled to the bridge link, and the jaw assembly is coupled to an end of the second leg unit.

27. The adult walker of claim 26, wherein the bridge link is formed to include an interior channel and an exterior wall formed to include an elongated slot opening into the interior channel and the lock unit includes a pin carrier mounted for back-and-forth sliding movement in the interior channel, the lock pin is coupled to the pin carrier to move therewith relative to the bridge link and arranged to extend through the elongated slot, and a spring is arranged to lie in the interior channel and is configured to define means for yieldably moving the pin carrier in the interior channel to urge the lock pin to engage one end of the elongated slot.

28. The adult walker of claim 26, wherein the jaw assembly is U-shaped and is positioned to cover at least a portion of the bridge link when the side frame is in the unfolded use position.

29. The adult walker of claim 26, wherein the jaw assembly is formed to include a pin-receiver channel defining a pin-capture notch and a pin-keeper passage.

30. The adult walker of claim 29, wherein the lock pin is positioned to engage the pin-receiver channel when the side frame is in the unfolded use position.
